(19) United States
(12) Patent Application Publication
(10) Pub. No.: US 2002/0093269 A1
(43) Pub. Date: Jul. 18, 2002

(54) Slot area undercut for segmented stators

(76) Inventors: Bernard G. Harter, Lynnville, IN (US); Richard E. Hartsfield JR., Chesterfield, MO (US); James A. Wafer, Belleville, IL (US)

Correspondence Address: Harness, Dickey & Pierce, P.L.C., P. O. Box 828, Bloomfield Hills, MI, 48303, US

(21) Appl. No.: 09/761,125

(22) Filed: Jan. 16, 2001

(51) Int. Cl. H02K 1/12; H02K 1/14

(52) U.S. Cl. 310/254; 310/216

(57) ABSTRACT

A stator for an electric machine such as a motor or a generator includes a plurality of stator segment assemblies. The stator segment assembly includes a stack of stator plates forming a stator segment core. The stator plates include an outer rim section and a tooth section that extends radially inwardly from a center portion of the outer rim section. A radially inner surface of the outer rim section is generally perpendicular to the tooth section. Undercut portions are formed in the radially inner surface of the outer rim section adjacent to the center portion. The undercut portions increase slot area and allow additional winding wire to be wound around the stack. The additional winding wire increases the current carrying capacity of the electric machine through reduced resistance or increased torque per unit volume.

### FIELD OF THE INVENTION

This invention relates to electric machines and more particularly to stators for electric machines.

### BACKGROUND OF THE INVENTION

Electric machines, such as motors and generators, typically include a stationary stator that defines salient poles and inter-pole slots that are located between the salient poles. The electric machines also include a rotor that defines rotor poles and that rotates relative to the stator. In brushless permanent magnet (BPM) electric machines, the stator is often segmented. In U.S. patent Ser. No. ______ that is entitled “Segmented Stator Switched Reluctance Machine” and that is commonly assigned, a segmented stator for a switched reluctance machine is disclosed.

The segmented stator includes a plurality of stator segment assemblies. Each stator segment assembly, in turn, includes a stack of stator plates forming a stator segment core, winding wire, terminals, end caps and insulating material. The end caps are typically made of a magnetically non-conducting material and are attached to opposite face surfaces of the stator segment core. The winding wire is wound around the stator segment core and the end caps. The end caps position the winding wire and help prevent winding creep. The insulating material is typically located between the winding wire and the stator segment core and on an outer surface of the winding wire between adjacent stator segment assemblies. The terminals typically project from one of the end caps. One end of the winding wire is connected to one of the terminals and an opposite end is connected to the other terminal. A circuit board or another connection device couples the terminals of the stator segment assemblies to a drive circuit. The drive circuit generates commutating currents that are output to the terminals of the stator segment assemblies, which in turn generates a rotating magnetic field within the stator.

The number of winding turns and the amount of the inter-pole slots that is filled by the winding wire impacts the performance of the electric machine. Slot fill is the percentage of the slot between adjacent salient poles that is filled by winding wire. As the slot fill percentage increases and the winding turns increase, the torque density of the electric motor also increases. Designers of electric machines continually seek to maximize the torque density of the electric machines to decrease material costs and to reduce the size of products incorporating the electric machine. In addition, designers seek to manufacture the stator segment assemblies in a highly uniform manner to provide consistent performance from one machine to another and from one stator segment assembly to another.

Some applications such as automobiles provide a relatively low input voltage and a relatively high input current. To accommodate these applications, the diameter of the winding wire is typically increased to carry the higher current. It is far more difficult to precisely wind the stator segment cores with the larger diameter winding wire. In addition, the number of turns that can be accommodated in the stator slots decreases as a function of wire diameter. The slot fill percentage also generally decreases as the wire diameter increases. The precision with which the stator segments are wound becomes more important as the wire diameter increases and the number of turns decrease because each turn has a more significant impact.

Conventional methods of winding the stator segment cores include transfer wiring and needle wiring. The needle wiring method employs a machine that weaves the winding wire through the slots of the assembled stator. The transfer wiring method winds the wire off of the stator and then transfers the prewound winding wire onto the stator teeth of the stator. Both the transfer wiring and the needle wiring methods leave a significant amount of wiring in end loops that extend from ends of the stator. The end loops decrease the efficiency of the electric machine. Both the transfer wiring method and the needle wiring method fail to wind the stators consistently, which creates performance variations from one stator segment assembly to the next. The performance variations, such as differences in resistance and inductance, cause problems for the drive circuits and often prevent sensorless operation in switched reluctance machines.

In addition to the transfer wiring and needle wiring methods, computer numerical control (CNC) winding machines are also used to precisely wind the individual stator segment cores. When CNC machines are used, an outer arcuate rim section of the stator segment core is typically rotated about a radial center line of a tooth section of the stator segment core. A radially inner surface of the outer arcuate rim section of the stator segment also typically has an arcuate shape. When a start wire is wound around the tooth section of the stator segment core, outer ends of the arcuate radially inner surface of the rim section often interfere with the placement of the winding wire. As a result, accurate winding is difficult to achieve.

Therefore, methods and apparatus for winding stator segment cores that improve winding precision, that increase torque density, that increase the number of turns, and that increase the slot fill are desirable. In addition, methods and apparatus for creating stator segment assemblies with uniform electrical characteristics from one stator segment to another is also desirable.

### SUMMARY OF THE INVENTION

A stator segment core for a stator of an electric machine according to the invention includes a stator plate with an outer arcuate rim section and a tooth section that extends radially inwardly from a center portion of the outer arcuate rim section. A radially inner surface of the outer arcuate rim section is generally perpendicular to the tooth section. A first undercut portion is formed in the radially inner surface of the outer arcuate rim section adjacent to one side of the center portion. The first undercut portion increases slot area and allows additional winding wire around the first tooth section. The first undercut portion also provides clearance for a start turn of winding wire that is wound on the stator segment core. The stator plate according to the invention also allows more accurate placement of the winding wire. One or more additional turns can be wound around the stator segment core, which increases torque density. In addition, a start turn of the winding wire is in an unobstructing position when located in the first undercut portion.

In other features of the invention, the stator plate includes a second undercut portion on the radially inner surface of the arcuate section adjacent to an opposite side of the center portion of the arcuate section. The first and second undercut portions have a “U”-shaped cross-section in one embodiment. Alternately, the second undercut portion extends over one-half of a distance between the opposite side of the center portion of the outer arcuate rim section and a circumferential end of the outer arcuate rim section. By providing the second undercut portion, additional winding wire can be wound around the stator segment core to increase torque density.

In other features of the invention, a stator segment assembly also includes a first end cap having a radially outer section, a middle section that extends radially inwardly from a center portion of the radially outer section and an inner section that is connected to the middle section. A radially inner surface of the outer section is generally perpendicular to sides of the middle section. The radially inner surface of the radially outer section includes a third undercut portion that is adjacent to the center portion of the radially outer section. The first end cap also provides clearance for additional winding wire. The start turn of the winding wire can be positioned in an unobstructing position in the third undercut portion. The end caps limit winding creep during use and provide phase-to-ground electrical insulation.

In other features of the invention, the stator segment core includes a stack of stator plates. First and second end caps are located adjacent opposite face surfaces of the stack. The first and second end caps include third and fourth undercut portions that register with the first undercut portion of the stacked stator plates. Winding wire is wound around the first and second end caps and the stacked stator plates.

Other objects, features and advantages will be apparent from the specification, the drawings and the claims that follow.

### BRIEF DESCRIPTION OF THE DRAWINGS

FIG. 1 is an end view of a rotor, a stator with stator segment cores, and a housing of an electric machine;

FIG. 2 is a sectional view of a stator segment core that includes first and second slot undercut portions, windings and an insulating material;

FIG. 3 is a sectional view of an alternate stator segment core that includes a slot undercut portion, an elongated slot undercut portion and windings;

FIG. 4A is a side view of an end cap for a segmented stator that includes a slot undercut;

FIG. 4B is a plan view of the end cap of FIG. 4A that is positioned over a stator plate of a stator segment core; and

FIG. 4C is a side view of the stator segment core and the end caps that form part of a stator segment assembly.

### DETAILED DESCRIPTION OF THE PREFERRED EMBODIMENTS

The ensuing detailed description provides preferred exemplary embodiments only and is not intended to limit the scope, applicability or configuration of the present invention. Rather, the ensuing detailed description of the preferred exemplary embodiments will provide those skilled in the art with an enabling description for implementing the preferred exemplary embodiments of the present invention. It being understood that various changes may be made in the function and arrangement of the elements without departing from the spirit and scope of the invention as set forth in the appended claims.

Novel stator plates and end caps and a method of winding the stator segment assembly according to the present invention improve the current carrying capacity of electric machines. The stator plates and the end caps provide a slot undercut portion to increase available slot area and to provide an unobstructing position for a start turn of winding wire that is wound around the stator plates and end caps. The slot undercut portion allows additional winding wire to be wound around the teeth of the stator plates.

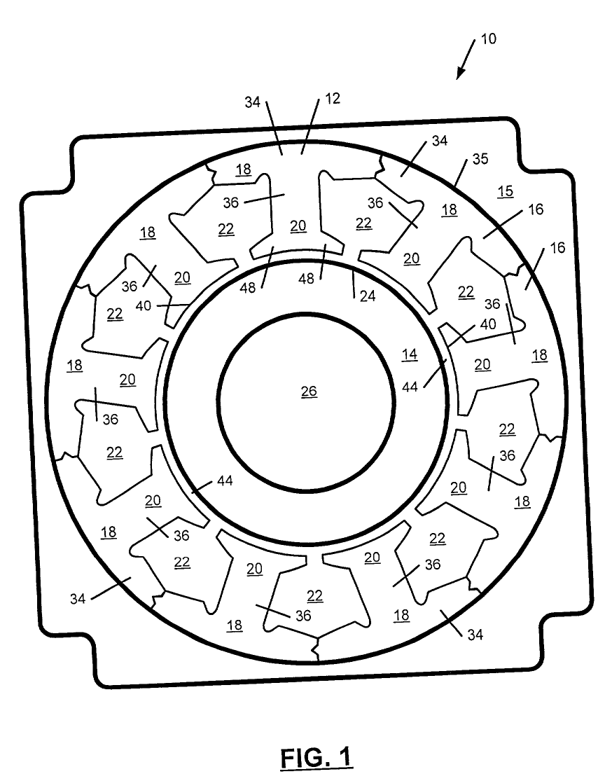

Referring now to FIG. 1, an electric machine such as a brushless permanent magnet motor or generator is illustrated and is generally designated 10. While the electric machine 10 is shown as a brushless permanent magnet motor 10, the present invention has application to other types of motors such as reluctance motors. The electric machine 10 includes a stator 12, a rotor 14 and a housing 15. As will be described further below in conjunction with the remaining FIGS., the stator 12 includes a plurality of stator segment assemblies each including a stack of stator plates 16 forming a stator segment core 18, end caps, winding wire, and terminals on insulating material. For purposes of illustration, however, FIG. 1 shows only an outermost stator plate 16 of the stator segment cores 18. Other stator plates 16 forming the stator segment core 18 also have a similar design as the outermost stator plate 16. The stator segment cores 18 define salient poles 20 and interpole slots 22. The rotor 14 includes a plurality of permanent magnets (not shown) that are arranged in a conventional manner on an outer surface 24 of the rotor 14. Alternately the rotor can include a spoke magnet rotor having a rotor core with internal radial slots that receive permanent magnets, a rotor having arc magnets, or any other conventional rotor. The rotor 14 rotates relative to the stator 12 and the housing 15 on a shaft 26.

The stator segment cores 18 are generally “T”-shaped. The stator plates 16 of the stator segment cores 18 include an outer arcuate rim section 34 that extends in a circumferential direction. The outer arcuate rim section 34 is shaped to provide an interference fit with an inner surface 35 of the housing 15 when the electric machine 10 is assembled. A tooth section 36 extends radially inwardly from the outer arcuate rim section 34. Radially inner ends 40 of the stator segment cores 18 have an arcuate shape to provide a uniform air gap 44 between the radially inner ends 40 of the tooth section 36 and the outer surface 24 of the rotor 14. Radially inner ends 48 of the salient poles of the stator plates 16 includes tangs 48 that reduce the reluctance (and the distance) between the adjacent stator teeth sections 36. Windings (not shown in FIG. 1) are wound around the tooth section 36 of each stator segment core 18. Preferably, the windings substantially fill the inter-pole slots 22 that are located between the adjacent stator segment cores 18.

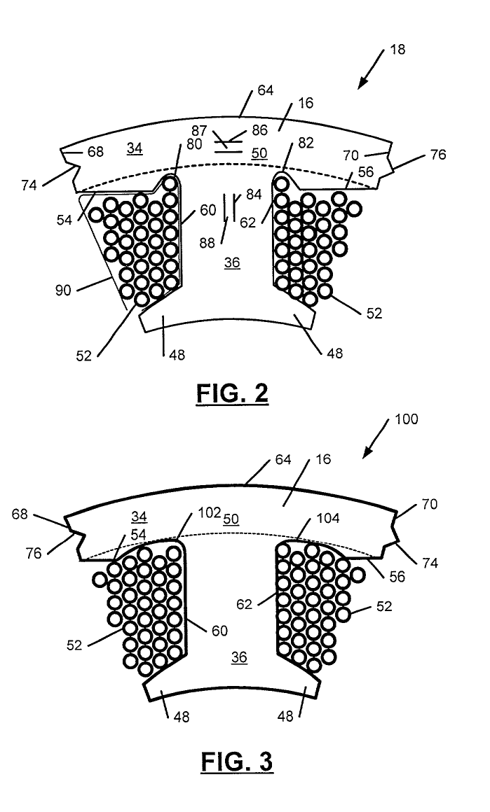

Referring now to FIG. 2, the stator segment core 18 according to the present invention is illustrated in further detail. The stator plates 16 include the outer arcuate rim section 34 and the tooth section 36. The tooth section 36 extends from a center portion 50 of the outer arcuate rim section 34. Winding wire 52 is preferably wound around the tooth section 36 using computer numerical control (CNC) winding machines or other suitable methods. The winding wire 52 has a diameter that is sufficiently large to accommodate the current that is to be carried by the electric machine 10. The outer arcuate rim section 34 includes radially inner surfaces 54 and 56 that are generally perpendicular to opposite sides 60 and 62 of the tooth section 36. A radially outer surface 64 of the outer arcuate rim section 34 forms an interference fit with an inner surface of the housing 15 after assembly. Opposite ends 68 and 70 of the outer arcuate rim section 34 include an optional groove 74 and an optional tongue 76. Adjacent stator segment cores 18 align with each other via the grooves 74 and the tongues 76. The groove 74 and the tongue 76 can have other shapes such as a “V”-shape, an arcuate shape such as a “C”-shape, a trapezoid shape or any other suitable shape. Because the stator segment assemblies are typically press fit or hot dropped into the housing 15, the grooves 74 and tongues 75 can be omitted.

The radially inner surface 54 of the outer arcuate rim section 34 includes a first undercut portion 80. In a preferred embodiment, the first undercut portion 80 is sufficiently large to accommodate the diameter of the winding wire 52 that is employed without the winding wire significantly protruding radially inwardly beyond the radially inner surface 54. An optional second undercut portion 82 similarly provides clearance for the winding wire 52. The first and second elongate slots 80 and 82 can be made large enough to accommodate two or more winding wires if the flux path permits.

The stator plates 16 are die cut from a magnetic field conducting material. At the same time that the stator plates 16 are die cut, radial and lateral slits 84 and 86 are also made in the stator plates 16 and central portions 87 and 88 between the slits 87 and 88 are deformed. Each of the radial and lateral slits 84 and 86 include a pair of parallel cuts. When the stator plates 16 are stacked, central portions 87 and 88 of one stator plate 16 are press fit into central portions 87 and 88 of an adjacent stator plate 16. The press fit central portions 87 and 88 hold the stack of stator plates 16 together to form the stator segment core 18. An insulating material 90 is positioned between the winding wire 52 and the tooth section 36, in the undercut portions 80 and 82, and along the radially inner surfaces 54 and 56. The insulating material 90 may also be positioned on an outer surface of the winding wire 52 between the adjacent stator segment cores 18.

When assembling the stator segment assemblies, the stator segment core 18 and end caps (that are illustrated and described further below) are preferably wound by the CNC machine by rotating the stator segment core 18 about a radial center line. A start wire is positioned in the first undercut portion 80 and extends axially from the stack. Because the radially inner surfaces 54 and 56 are perpendicular to the tooth section 36 and the start wire is in an unobstructing position, the remaining winding wire 52 can be accurately positioned. In addition, the first undercut portion 80 allows one or more additional winding turns to be wound around the stator segment core 18 and the end caps. The additional winding turns can make a significant difference in low voltage, high current applications that have a relatively low number of winding turns. For example, an additional turn provides 5-10% additional torque per unit current capacity for stator segment assemblies having 10-15 turns.

Referring now to FIG. 3, an alternate stator segment core 100 according to the present invention is illustrated in further detail. Reference numbers from FIG. 2 will be used where appropriate to identify similar elements. The alternate stator segment core 100 has a construction that is similar to the stator segment core 18. The first and the second undercut portions 80 and 82 of the stator segment core 18 are replaced by elongate undercut portions 102 and 104. As can be appreciated, the elongate undercut portions 102 and 104 provide addition area for receiving the winding wire 52. The elongate undercut portions 102 and 104 allow additional winding turns to be wound around the stator segment core 100.

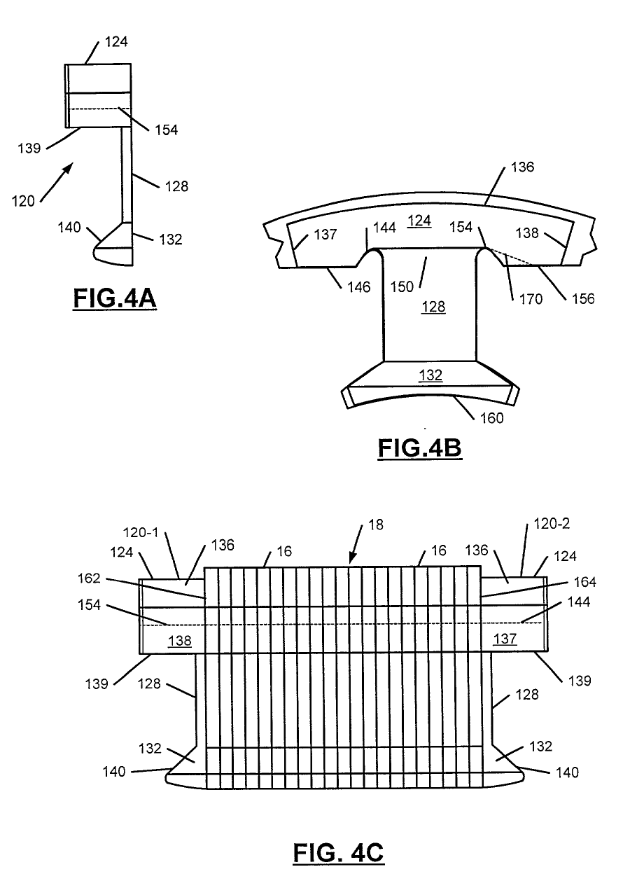

Referring now to FIGS. 4A and 4B, an end cap 120 that is used with the stator segment core 18 is shown to include a radially outer section 124, a middle section 128 and a radially inner section 132. Radially outer section 124 includes an outer arcuate rim section 136, opposite ends 137 and 138, and an upper axial projection 139 that extends in an axial direction. The radially inner section 132 includes a lower axial projection 140 that extends in an axial direction.

The end cap 120 includes a first undercut portion 144 that is formed on a radially inner surface 146 of the radially outer section 124. The first undercut portion 144 lies adjacent to a center portion 150 of the radially outer section 124. The first undercut portion 144 of the end cap 120 has a shape that is similar to the first undercut portion 80. A second undercut portion 154 is located on a radially inner surface 156 of the radially outer section 124. The second undercut portion 154 lies adjacent to an opposite side of the center portion 150.

The second undercut portion 154 of the end cap 120 has a shape that is similar to the second undercut portion 82. The radially inner surfaces 146 and 156 are preferably perpendicular to opposite sides of the middle section 128. The radially inner section 132 of the end cap 120 includes an arcuate surface 160 on a radially inner end thereof. The arcuate surface 160 is generally parallel to the radially inner end 40 of the tooth section 36. In an alternate end cap, an elongate undercut portion 170 substantially follows the elongate undercut portion 104 that is illustrated in FIG. 3.

In FIG. 4C, two end caps 120-1 and 120-2 are fastened to opposite face surfaces 162 and 164 of the stator segment core 18. The winding wire 52 is wound around the middle sections 128 of the end caps 120-1 and 120-2. The upper axial projections 139 and the lower axial projections 140 of the end caps 120-1 and 120-2 maintain the winding wire 52 on the stator segment core 18. The start wire is positioned in the first undercut portion 80 and the winding wire 52 is accurately positioned on the stator segment core 18 and the end caps 120.

The design of the stator plates and the end caps according to the present invention increases the number of turns that can be wound around the stator segment assembly. The increased turns are particularly advantageous in high current applications such as automobile applications. The additional turns also increase the torque density and the current carrying capacity of the electric machines which reduces packaging requirements for products incorporating the electric machines. In addition, the stator segment according to the invention allows the windings to be precisely placed which allows stator segment assemblies to provide consistent electrical performance from one machine to another and from one stator segment assembly to another. The end caps according to the invention also provide clearance for additional winding turns and prevent winding creep during use.

Those skilled in the art can now appreciate from the foregoing description that the broad teachings of the present invention can be implemented in a variety of forms. Therefore, while this invention has been described in connection with particular examples thereof, the true scope of the invention should not be so limited since other modifications will become apparent to the skilled practitioner upon a study of the drawings, the specification and the following claims.

What is claimed is:

1. A stator plate for a stator segment assembly of a stator of an electric machine comprising:
an outer rim section that includes a radially inner surface;
a tooth section extending radially inwardly from said outer rim section; and
a first undercut portion formed in said radially inner surface of said outer rim section.

2. The stator plate of claim 1 wherein said first undercut portion is adjacent to said tooth section and wherein said outer rim section is generally perpendicular to said tooth section.

3. The stator plate of claim 1 wherein said first undercut portion increases slot area and allows additional winding wire around said first tooth section.

4. The stator plate of claim 1 wherein said first undercut portion provides clearance for a start turn of winding wire on said stator segment.

5. The stator plate of claim 1 wherein said first undercut portion is generally “U”-shaped.

6. The stator plate of claim 1 wherein said stator is formed by a plurality of stator plates.

7. A stator segment assembly for a stator of an electric machine comprising:
a stator core including a stack of stator plates, each of said stator plates including an outer rim section, a tooth section extending radially inwardly from said outer rim section, a radially inner surface of said outer rim section that is generally perpendicular to said tooth section, and a first undercut portion formed in said radially inner surface of said outer rim section.

8. The stator segment assembly of claim 7 further comprising:
a first end cap attached to a face surface of said stack and having a radially outer section, a middle section extending radially inwardly from a center portion of said radially outer section, and an inner section connected to said middle section, wherein a radially inner surface of said outer section is generally perpendicular to sides of said middle section, and wherein said radially inner surface of said radially outer section includes a third undercut portion that is adjacent to said center portion of said radially outer section.

9. The stator segment assembly of claim 7 further comprising:
first and second end caps that are located adjacent opposite face surfaces of said stack, wherein said first and second end caps include third and fourth undercut portions that register with said first undercut portion of said stack.

10. The stator segment assembly of claim 9 further comprising:
windings that are wound around said first and second end caps and said stack.

11. The stator segment assembly of claim 10 further comprising:
an insulating material that is located between said windings and said stack.

12. The stator segment assembly of claim 7 further comprising:
a tongue formed in one circumferential end of said outer rim section and a groove formed in an opposite circumferential end of said outer rim section.

13. The stator segment assembly of claim 12 wherein said tongue and said groove are “V”-shaped.

14. The stator segment assembly of claim 12 wherein said tongue and said groove are “C”-shaped.

15. The stator segment assembly of claim 7 wherein said electric machine is a brushless permanent magnet motor.

16. The stator segment assembly of claim 7 wherein said electric machine is a switched reluctance motor.

17. The stator segment of claim 7 further comprising:
a second undercut portion in said radially inner surface of said outer rim section.

18. The stator segment of claim 17 wherein said first undercut portion provides sufficient clearance for a plurality of winding turns.

19. A stator segment assembly for an electric machine comprising:
a stack of stator plates that are generally “T”-shaped and include an outer rim section, a tooth section that extends radially inwardly from a center portion of said outer rim section, a radially inner surface of said outer rim section that is generally perpendicular to said tooth section, and a first undercut portion in said radially inner surface of said outer rim section that is adjacent to said center portion and that is generally “U”-shaped.

20. The stator segment assembly of claim 19 further comprising:
an end cap that is generally “T”-shaped and includes an outer section, a middle section extending inwardly from a center portion of said outer section, and an inner section, wherein a radially inner surface of said outer section of said end cap is generally perpendicular to sides of said middle section, and wherein a second undercut portion is formed in said radially inner surface of said outer section and is adjacent to said center portion of said outer section.

21. The stator segment assembly of claim 19 further comprising:
first and second insulating end caps that are attached to opposite face surfaces of said stack.

22. The stator segment assembly of claim 21 further comprising:
windings that are wound around said first and second end caps and said stack; and
an insulating material that is located between said windings and said stack.

22. A method of winding a stator segment assembly of a stator of an electric machine comprising the steps of:
winding a start wire turn around a tooth section of a stator segment;
positioning a portion of said start wire turn in a first undercut portion of said stator segment; and
winding additional turns around said tooth section.

23. The method of claim 22 further comprising the step of:
positioning said start wire turn in a second undercut portion of said stator segment prior to winding said additional turns.

24. The method of claim 22 further comprising the step of:
positioning said start wire turn in an elongate undercut portion of said stator segment.

25. The method of claim 22 wherein said additional winding turns are wound using a computer numeric control (CNC) machine.
